(19) United States
(12) Patent Application Publication
(10) Pub. No.: US 2012/0086869 A1
(43) Pub. Date: Apr. 12, 2012

(54) USING TV TO PROGRAM UNIVERSAL REMOTE COMMANDER

(75) Inventor: STEVEN FRIEDLANDER, San Diego, CA (US)

(73) Assignee: SONY CORPORATION

(21) Appl. No.: 12/901,114

(22) Filed: Oct. 8, 2010

(51) Int. Cl. H04N 5/44

(52) U.S. Cl. 348/734; 348/E05.096

(57) ABSTRACT

A TV prompts a user to point a device remote commander (RC) at the TV and to press a key on the device RC where the key is associated with a predetermined infrared signal. The TV then accesses a data store on an Internet server with a request to correlate the coded signal from the device RC to a list of devices. A list of devices is then presented to the user. The user then selects a device from the list, which causes the TV to send command codes for the device to a universal remote commander (URC). The user is thereafter able to control the audio video device using the URC instead of or in addition to the device RC.

### I. FIELD OF THE INVENTION

The present application relates generally to programming universal remote commanders, which are sometimes referred to as universal remote controls.

### II. BACKGROUND OF THE INVENTION

Universal remote commanders allow people to control many different devices, such as home entertainment devices, with a single remote commander. Thus, that single remote commander, once programmed with the proper infrared (IR) codes, can thereafter control multiple devices such as, e.g., a television (TV), a video disc player, and a stereo system.

However, programming a universal remote commander with the proper IR codes is often complicated and frustrating. IR codes for each device have to be provided to the universal remote commander, often times requiring manual entry of the IR codes. Manual entry often involves a user pressing a long sequence buttons on the remote commander and/or searching through a dense manual of IR codes for the proper IR code to enter. Thus, it may be appreciated that the process of programming a universal remote commander can be confusing, complex, laborious and/or technically difficult.

Moreover, the process for programming IR codes into a universal remote commander often necessitates that a user make a service call when the user is unable to successfully program the universal remote commander. These service calls can result in additional monetary charges to the user for the assistance received to program a universal remote commander. Thus, an excessive consumption of the user's time and money often results when programming a universal remote commander.

### SUMMARY OF THE INVENTION

Accordingly, a method includes presenting on a video display of a controlling component a prompt for a user to point a device remote commander (RC) at the video display and to press a key on the RC. The device RC may be configured to input coded signals to an audio video device, where the audio video device may be configured to communicate audio video signals to the controlling component.

The method may also include wirelessly receiving at least one coded signal from the device RC, accessing a data store with a request to correlate the coded signal to a list of plural devices, and receiving the list from the data store along with wireless command codes for respective devices on the list. The method also includes presenting the list on the display, prompting a user to select a device from the list, and, responsive to a user selection of a device from the list, sending the command codes for the device to a universal remote commander (URC) to enable a user to control the audio video device using the URC.

In certain non-limiting embodiments, the method may also include that the data store be accessed through an Internet server. Further, the controlling component may be a TV and the audio video device may be either a video disk player or a video game console.

Additionally, the method may include that the audio video device be a first audio video device and the device RC be a first device RC. The method may further include presenting, on the video display of the controlling component, a prompt for a user to point a second device RC at the video display and press a key on the second device RC. The second device RC may be configured to input coded signals to the second audio video device, where the second audio video device may be configured to communicate audio video signals to the controlling component.

The method may also include wirelessly receiving at least one coded signal from the second device RC and accessing data store with a request to correlate the coded signal to a list of plural devices. The method may also include receiving the list from the data store along with wireless command codes for respective devices on the list, then presenting the list on the display. A user may be prompt to select a device from the list, and, responsive to a user selection of a device from the list, the command codes for the device are sent to the URC to enable a user to control the second audio video device using the URC.

In another aspect, a system includes a TV and at least one audio video device communicating with the TV where the TV may execute logic including presenting, on a video display of the TV, a prompt for a user to point a device remote commander (RC) at the video display and press a key on the device RC. The device RC may be configured to input coded signals to an audio video device in non-limiting embodiments.

The logic of the system may also include wirelessly receiving at least one coded signal from the device RC, accessing a data store with a request to correlate the coded signal to a list of plural devices, and receiving the list from the data store. The list may be presented on the display along with a prompt to select a device from the list. Responsive to a user selection of a device from the list, command codes for the device are sent to a URC to enable a user to control the audio video device using the URC. The URC is different from the device RC.

In yet another aspect, a TV includes a processor and a display controlled by the processor. The processor may receive a predetermined signal from a device RC, access an Internet server, provide data representing the predetermined signal to the server, receive from the server a list of devices, and present on the display the list along with a prompt to select an entry on the list.

The details of the present invention, both as to its structure and operation, can best be understood in reference to the accompanying drawings, in which like reference numerals refer to like parts, and in which:

### BRIEF DESCRIPTION OF THE DRAWINGS

FIG. 1 is a block diagram of a non-limiting example system in accordance with present principles;

FIG. 2 is a flow chart of non-limiting logic for enabling a person to program a URC in accordance with present principles.

FIGS. 3-5 are non-limiting example screen shots of UIs that can be presented on the TV in accordance with present principles.

### DETAILED DESCRIPTION OF THE PREFERRED EMBODIMENT

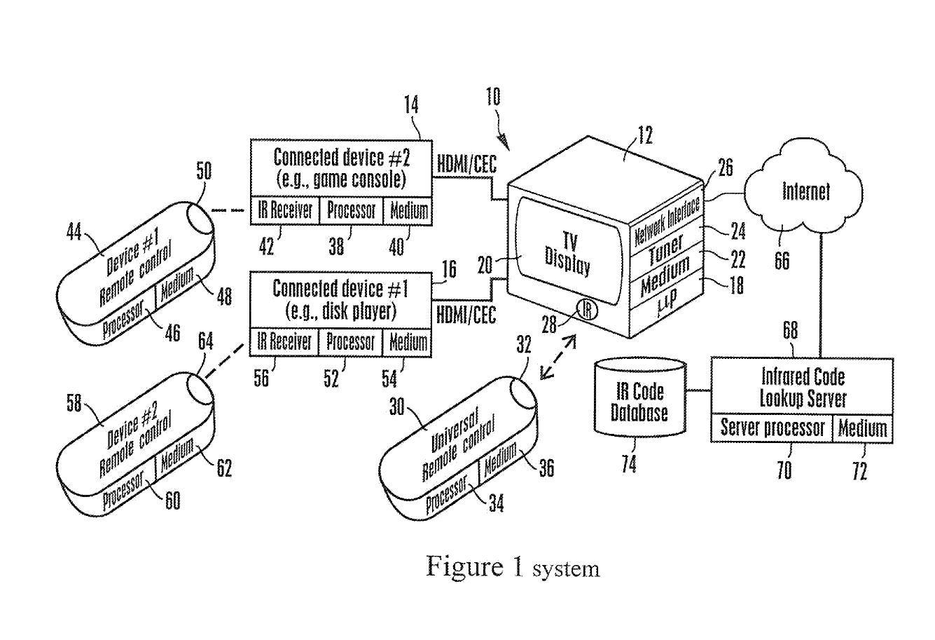

Referring initially to the non-limiting embodiment show in FIG. 1, a home entertainment system 10 has a TV 12, a connected device 14 and a connected device 16. In non-limiting embodiments, the connected device 14 and the connected device 16 may be, without limitation, a video disc player and a video game console, respectively. Further, the device 14 and device 16 are capable of bi-directional communication with the TV 12. In non-limiting embodiments, this communication may occur through a wired connection such as HDMI/CEC connection or through a wireless connection using, e.g., Bluetooth technology.

The TV 12 shown in FIG. 1 also has a digital processor 18 which can control a visual display 20. Further, the processor 18 may access one or more computer readable data storage medium(s) 22 such as but not limited to RAM-based storage (e.g., a chip implementing dynamic random access memory (DRAM)) or flash memory or disk-based-storage. Moreover, software code implementing the present logic executable by the TV 12 may be stored on the medium(s) 22 to undertake present principles.

Still in reference to FIG. 1, a TV tuner 24 on the TV 12 can receive TV signals from a source such as a set-top box, satellite receiver, cable head end, terrestrial TV signal antenna, etc. Signals from the tuner 24 are sent to the processor 18 for presentation on the display 20.

Additionally, the TV 12 may be capable of accessing the Internet in non-limiting embodiments. Thus as shown in FIG. 1, there may be a network interface 26 such as a wired or wireless modem or wireless telephony transceiver that may communicate with the processor 18 to provide connectivity to a wide area network such as the Internet.

The TV 12 of FIG. 1 also has an infrared (IR) transceiver 28 capable of bi-directional communication with other electronic devices such as the universal remote commander (URC) 30. The URC 30 has an IR transceiver 32 which is also capable of bi-directional communication with other electronic devices such as the TV 12.

It is to be understood that the transceiver 28 and transceiver 32 may both send and receive infrared signals in the non-limiting embodiment shown in FIG. 1. However, it is to be further understood that other wireless communication means, and also wired communication means, may be used in accordance with present principles.

Still in reference to the URC 30 of FIG. 1, the URC 30 has a digital processor 34 and one or more computer readable data storage medium(s) 36. The medium(s) 36 may be, without limitation, RAM-based storage (e.g., a chip implementing dynamic random access memory (DRAM)) or flash memory or disk-based-storage.

As referenced above, the home entertainment system 10 has a connected device 14 and a connected device 16. The connected device 14, which may be a video disc player in non-limiting embodiments, has a processor 38, one or more computer readable data storage medium(s) 40 and an IR transceiver 42. The processor 38, storage medium(s) 40 and transceiver 42 may be substantially similar in function and configuration to the processor 18, storage medium(s) 22 and IR transceiver 28, respectively.

The connected device 14 also has a device remote commander 44 associated with it. The device RC 44 has a digital processor 46, one or more computer readable data storage medium(s) 48 and an IR transceiver 50. The processor 46, medium(s) 48 and IR transceiver 50 may be substantially similar in function and configuration to the processor 34, storage medium(s) 36 and IR transceiver 32, respectively.

Still in reference to FIG. 1, the connected device 16, which may be a video game console in non-limiting embodiments, has a processor 52, one or more computer readable data storage medium(s) 54 and an IR transceiver 56. The processor 52, storage medium(s) 54 and transceiver 56 may be substantially similar in function and configuration to the processor 18, storage medium(s) 22 and IR transceiver 28, respectively.

The connected device 16 also has a device remote commander 58 associated with it. The device RC 58 has a digital processor 60, one or more computer readable data storage medium(s) 62 and an IR transceiver 64. The processor 60, medium(s) 62 and IR transceiver 64 may be substantially similar in function and configuration to the processor 34, storage medium(s) 36 and IR transceiver 32, respectively.

As referenced above, there is a network interface 26 that may communicate with the processor 18 to provide connectivity to a wide area network such as the Internet. Thus, the TV 12 of FIG. 1 may be connected to the Internet 66 through a wired connection, such as a USB connection, or a wireless connection, such as using Bluetooth technology. The internet 66 has access to a server 68, the server 68 being classified as an “IR code look-up server” for illustrative purposes in the non-limiting embodiment of FIG. 1.

Moreover, the server 68 has a server processor 70 and one or more data storage medium(s) 72 such as but not limited to RAM-based storage (e.g., a chip implementing dynamic random access memory (DRAM)) or flash memory or disk-based-storage. Further, the processor 70 may access an IR code database 74. The IR code database 74 may have IR codes for various home entertainment devices and systems, such as IR codes for the TV 12, connected device 14 and connected device 16.

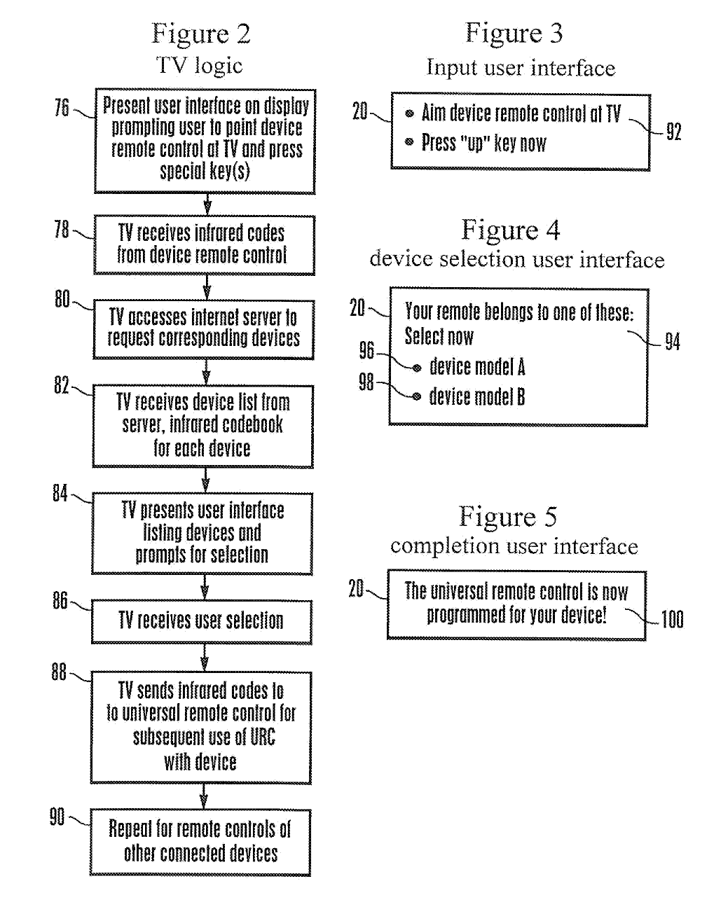

Now in reference to FIG. 2, a flow chart of the non-limiting exemplary logic for enabling a person to program a URC in accordance with present principles is shown. Beginning at block 76, an “input” user interface (UI) is presented on the display 20 and prompts a user to point a device RC, such as the device RC 44 or the device RC 58 described above, at the TV 12 and to press a particular and/or special key(s). Then at block 78 the TV 12 receives IR codes from the device RC.

Moving to block 80 of FIG. 2, the TV 12 then accesses an Internet server, such as the server 68 described above, and requests the IR codes for the corresponding device(s) for which it received IR code(s). The TV then receives a device list from the server at block 82. The device list may also be accompanied by an IR codebook for each device.

The TV 12 then presents a “device selection” UI at block 84 that lists possible devices based on the IR codes that the TV 12 had previously received and prompts a user to select the appropriate device. Then at block 86 the TV 12 receives a user's selection of a device on the list. The TV 12 then sends IR codes to a URC, such as the URC 30 referenced in FIG. 1, at block 88 for subsequent use of the URC with the device.

Concluding the logic of FIG. 2 at block 90, the logic may be repeated for device remote commanders of other connected devices. Thus, the logic may be repeated to program IR codes for additional devices into the URC.

FIGS. 3 through 5 are non-limiting illustrative examples of screen shots of UIs that can be presented on the TV 12 in accordance with present principles. In reference to FIG. 3, an “input” UI is shown. The “input” UI 92 may be presented on the display 20 referenced above. However, it is to be understood that the UI 92 is only a non-limiting illustrative example of what a user would see at block 76 in the logic described in FIG. 2.

Thus, the input UI 92 may prompt a user to aim a device RC at the TV 12 and then press a key such as the “up” key on the device RC while the device RC is pointed at the TV 12. However, it is to be understood that prompt on the UI 92 shown in FIG. 3 is exemplary and that the UI 92 may prompt a user to press more or different keys than the “up” key.

Now in reference to FIG. 4, a “device selection” UI is shown. The “device selection” UI 94 may be presented on the display 20 referenced above. However, it is to be understood that the UI 94 is only a non-limiting illustrative example of what a user would see at block 84 in the logic described in FIG. 2.

Thus, the UI 94 presents a list of devices and prompts a user to select the device to be controlled by the URC. For example, a user may be prompted to select either device model A 96 or device model B 98. However, it is to be understood that prompt on the UI 94 shown in FIG. 3 is exemplary and that the UI 94 may contain more, less or different types of devices on the list presented on the UI 94.

Moving on to FIG. 5, a “completion” UI is shown. The “completion” UI 100 may be presented on the display 20 referenced above after the TV 12 completes the programming of IR codes for a device on the URC. However, it is to be understood that the UI 100 is only a non-limiting illustrative example of what a user would see upon completion of programming a URC in accordance with present principles. Thus, the UI 100 notifies a user that a URC sought to be programmed has in fact been programmed for the intended device.

While the particular USING TV TO PROGRAM UNIVERSAL REMOTE COMMANDER is herein shown and described in detail, it is to be understood that the subject matter which is encompassed by the present invention is limited only by the claims.

What is claimed is:

1. Method comprising:
presenting on a video display of a controlling component a prompt for a user to point a device remote commander (RC) at the video display and press a key on the RC, the device RC being configured to input coded signals to an audio video device configured to communicate audio video signals to the controlling component;
wirelessly receiving at least one coded signal from the device RC;
accessing data store with a request to correlate the coded signal to a list of plural devices;
receiving the list from the data store along with wireless command codes for respective devices on the list;
presenting the list on the display;
prompting a user to select a device from the list;
responsive to a user selection of a device from the list, sending the command codes for the device to a universal RC (URC) to enable a user to control the audio video device using the URC.

2. The method of claim 1, wherein the data store is accessed through an Internet server.

3. The method of claim 1, wherein the controlling component is a TV.

4. The method of claim 1, wherein the audio video device is a video disk player.

5. The method of claim 1, wherein the audio video device is a game console.

6. The method of claim 1, wherein the audio video device is a first audio video device, the device RC is a first device RC, and the method further comprises:
presenting on the video display of the controlling component a prompt for a user to point a second device RC at the video display and press a key on the second device RC, the second device RC being configured to input coded signals to the second audio video device, the second audio video device being configured to communicate audio video signals to the controlling component;
wirelessly receiving at least one coded signal from the second device RC;
accessing data store with a request to correlate the coded signal to a list of plural devices;
receiving the list from the data store along with wireless command codes for respective devices on the list;
presenting the list on the display;
prompting a user to select a device from the list;
responsive to a user selection of a device from the list, sending the command codes for the device to the URC to enable a user to control the second audio video device using the URC.

7. System comprising:
a TV; and
at least one audio video device communicating with the TV, wherein the TV executes logic comprising:
presenting on a video display of the TV a prompt for a user to point a device remote commander (RC) at the video display and press a key on the device RC, the device RC being configured to input coded signals to an audio video device;
wirelessly receiving at least one coded signal from the device RC;
accessing a data store with a request to correlate the coded signal to a list of plural devices;
receiving the list from the data store;
presenting the list on the display;
prompting a user to select a device from the list;
responsive to a user selection of a device from the list, sending command codes for the device to a universal RC (URC) to enable a user to control the audio video device using the URC, the URC being different from the device RC.

8. The system of claim 7, wherein the data store is accessed through an Internet server.

9. The system of claim 7, wherein the audio video device is a video disk player.

10. The system of claim 7, wherein the audio video device is a game console.

11. The system of claim 7, wherein the device RC is a first device RC, and the TV further executes logic comprising:
presenting on the video display a prompt for a user to point a second device RC at the video display and press a key on the second device RC;
wirelessly receiving at least one coded signal from the second device RC;
accessing data store with a request to correlate the coded signal to a list of plural devices;
receiving the list from the data store along with wireless command codes for respective devices on the list;
presenting the list on the display;
prompting a user to select a device from the list;
responsive to a user selection of a device from the list, sending the command codes for the device to the URC to enable a user to control a second audio video device using the URC.

12. TV comprising:
processor;
display controlled by the processor;
the processor receiving a predetermined signal from a device remote commander (RC), accessing an Internet server, providing data representing the predetermined signal to the server, receiving from the server a list of devices, and presenting on the display the list along with a prompt to select an entry on the list.

13. The TV of claim 12, wherein the device RC is configured to send commands to an audio video device.

14. The TV of claim 13, wherein the processor executes logic comprising:
presenting on the display a prompt for a user to point the device RC at the TV and press a key on the device RC, the key being associated with the predetermined signal;
accessing a data store associated with the Internet server with a request to correlate the coded signal to a list of plural devices; and
responsive to a user selection of a device from the list, sending command codes for the device to a universal RC (URC) to enable a user to control the audio video device using the URC, the URC being different from the device RC.

15. The TV of claim 12, wherein the data store is accessed through the Internet server.

16. The TV of claim 13, wherein the audio video device is a video disk player.

17. The TV of claim 13, wherein the audio video device is a game console.
